(19) United States
(12) Patent Application Publication
(10) Pub. No.: US 2003/0155778 A1
(43) Pub. Date: Aug. 21, 2003

(54) Self-locking latch and locking system equipped with said latch

(76) Inventor: Michael Dorn, Elstertrebnitz (DE)

Correspondence Address: PEARNE & GORDON LLP, 526 SUPERIOR AVENUE EAST, SUITE 1200, CLEVELAND, OH, 44114-1484, US

(21) Appl. No.: 10/276,655

(22) PCT Filed: Jun. 8, 2001
(86) PCT No.: PCT/EP01/06537

(30) Foreign Application Priority Data
Jun. 9, 2000 (DE) 10028176.1

(51) Int. Cl. E05C 3/06

(52) U.S. Cl. 292/195

(57) ABSTRACT

A self-latching lock 1 with a bolt 2, catch 3, auxiliary catch pin 4 and reciprocator 5, in which the bolt 2 can be operated via a latch nut 6 or a closing thruster and is cocked for locking action by an elastic element 7 when the door is in the open position, in which, when the door leaf is engaged in the door rabbet, said bolt is released into its extended locking position by the action of at least the auxiliary catch pin 4, and which is provided with a nut-locking or idling device 8, preferably permitting deactivation by electric remote control, for the temporary activation of the latch function.

According to the invention, this remotely controllable nut-locking or idling device 8 permits in advantageous fashion the use of self-latching locks even in combination with centrally controlled closure systems.

This invention relates to a self-latching lock and to a closure system equipped therewith.

Prior art has produced a number of self-latching locks. For example, the German utility patent 298 12 665.6 describes a self-latching lock whereby, when the door leaf is swung into the door rabbet, the bolt that is cocked in the open position of the door by means of an elastic element snaps into the locked position that cannot be opened from the outside without a key. First, an auxiliary catch pin engages the edge of the striker plate, followed by the entry of the bolt into the striker plate, meaning that in this particular self-latching lock, the bolt will not extend in the full lock-out position until after the catch is fully engaged in the striker plate, thus preventing a premature lock-out extension that might cause damage on the door frame.

This and similar self-latching lock designs, being highly burglar-resistant, are widely used on the outside doors of buildings, apartments and hotel rooms. These doors do not usually have a latch on the outside, and they can therefore be locked simply by being pushed or pulled shut, and they cannot be opened from the outside without a key.

On the other hand, especially in the case of hotel facilities but also in office buildings, industrial plants etc., there is a growing trend toward the use of centrally controlled and monitored, partly computer-operated closing systems. By means of sensors installed in the locks, in the door panels or in the door frames and of suitable signal transmission lines or even wireless remote transmission systems, the closure state of all the doors connected to the door-lock control station can be centrally monitored, and it is possible in the same way to use the remotely controllable devices installed in the locks, doors, or door frames to change the closure state of the doors by locking or unlocking them.

However, the existing self-latching lock designs, while being highly intrusion-resistant and therefore lending themselves exceedingly well to installation in outside doors, apartment doors, hotel-room doors etc., have turned out to be relatively unsuitable for use in combination with existing centrally controlled closure systems, for the following reasons: In the closing systems currently in use, for instance on hotel-room doors, the lock barrel openings are generally covered from the outside, meaning that, there being no door latch, it is not possible by simple manual action to open the door from the outside. The door is instead opened by means of a magnetic card key in conjunction with the traditional door openers located in the striker plate and designed to release the catch. Employing the above-described conventional self-latching locks in combination with the existing closure systems is neither practical nor practicable since from the outside of the door its tumbler could be released only by operating the catch. Without a latch on the outside of the door, and given that the lock barrel opening is covered, a self-latching lock, once in the full lock-out state, cannot be opened from the outside.

It is for that reason that in conjunction with the conventional closure systems only locks without a self-latching feature have been used, which rather severely limits their burglar resistance since the tumbler of a door closed from the outside can be engaged only via the catch.

While in fact for instance DE-197 38 938 A1 describes locks with remotely controlled, electric-motor-driven pawls, these locks are physically complex and expensive and have therefore not so far been employed in closure systems. Electric motors sufficiently strong to move the bolt would take up a great deal of space in the lock, making the production of such locks impossible within the constraints of current standard dimensions and at reasonable cost.

Another possible use of self-latching locks in conventional closure systems could involve the addition of a remotely controllable self-latching inhibitor. Such a self-latching inhibitor could serve, whenever needed, to prevent full lock-out extension of the bolt, for instance when the door was closed from the outside so that, as in the case of locks without a self-latching feature, the door is held locked only via the catch and can be opened from the outside in traditional fashion by means of a magnetic card key and door opener.

That solution, however, does not make much sense because the high intrusion resistance of self-latching locks would not be utilized in the very situation where one leaves the room and closes the door from the outside.

It is therefore the objective of this invention to enhance the remote controllability of self-latching locks by simple, economical means in a way that even in existing, modern closure systems, these locks can fully utilize their burglar-resistant properties.

The invention is also aimed at reducing the complexity and cost of installing a centrally controlled closure system.

According to the invention, these objectives are achieved by the characterizing features specified in claims 1 and 17. Claims 2 to 16 describe the features of advantageous design versions of this invention.

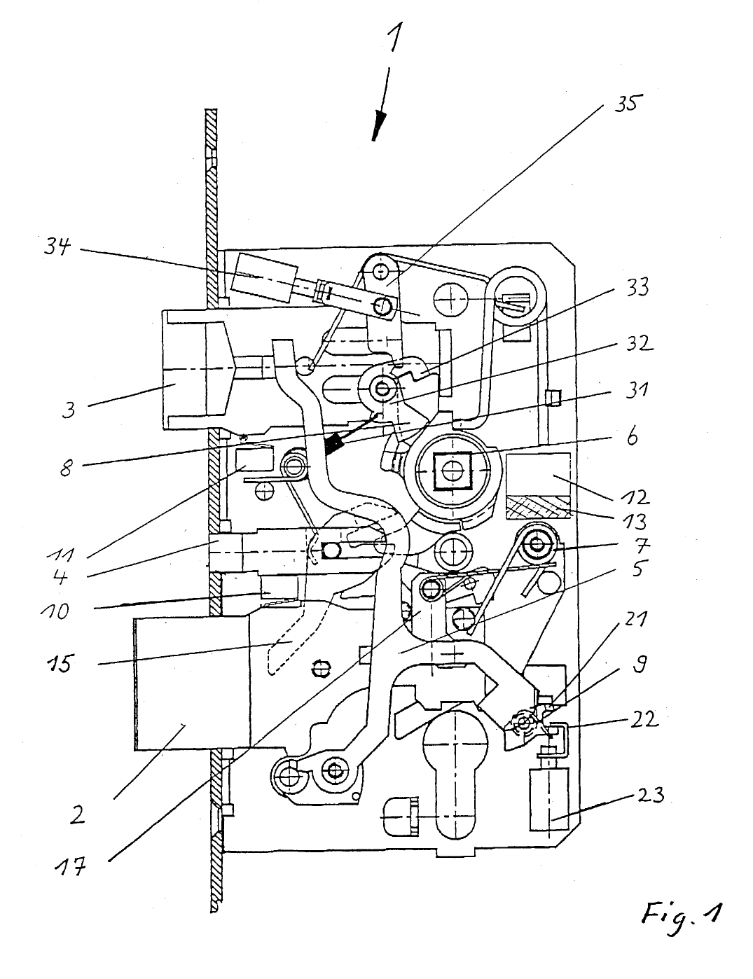

This invention is explained below in more detail by means of preferred implementation examples and with reference to FIGS. 1 to 4.

FIG. 1 is a lateral, partly cutaway view of the inner mechanism of a self-latching lock per this invention, with the cover removed and some of the components illustrated in schematic fashion;

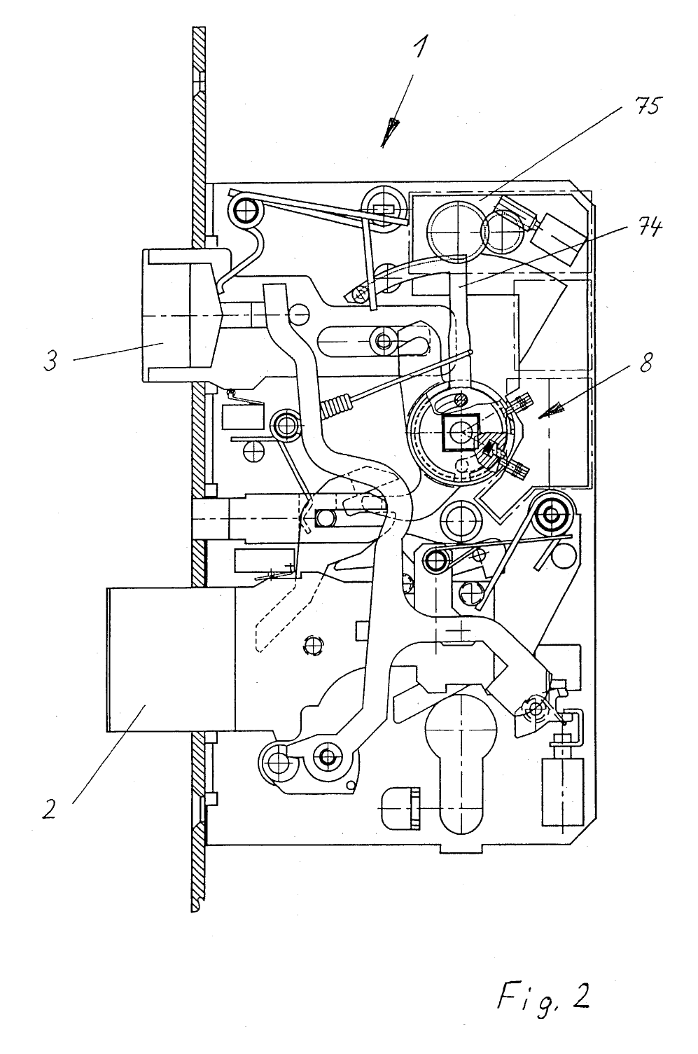

FIG. 2 is a view, similar to that in FIG. 1, of another design version of a self-latching lock per this invention, with a nut idling feature and a gear-segment lever-driven generator module for the point-of-use generation of the energy needed to operate the electrical components within the lock;

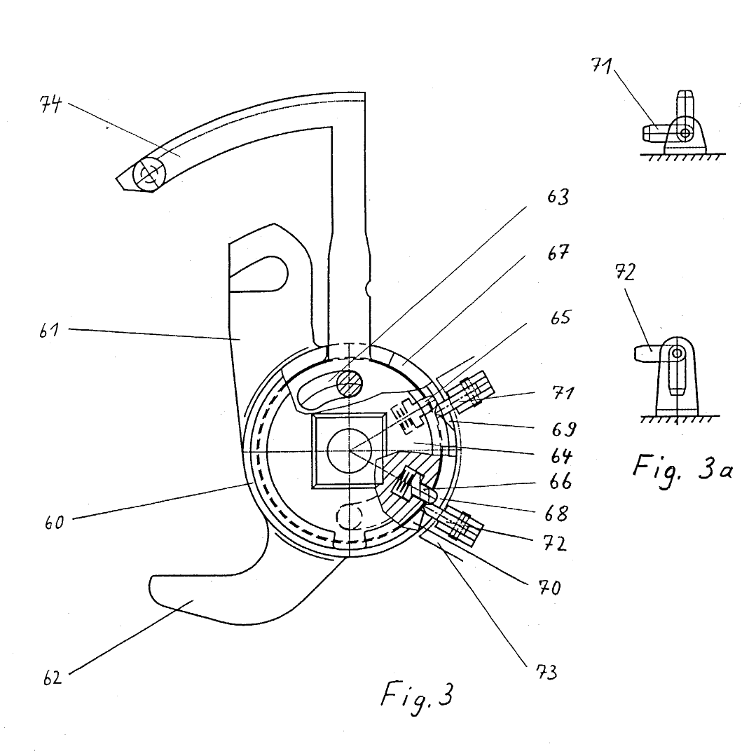

FIG. 3 is a detailed illustration of the nut idling feature required for a lock according to this invention, shown in FIG. 2;

FIG. 3a is a lateral aspect of the actuators shown in the top view of FIG. 3;

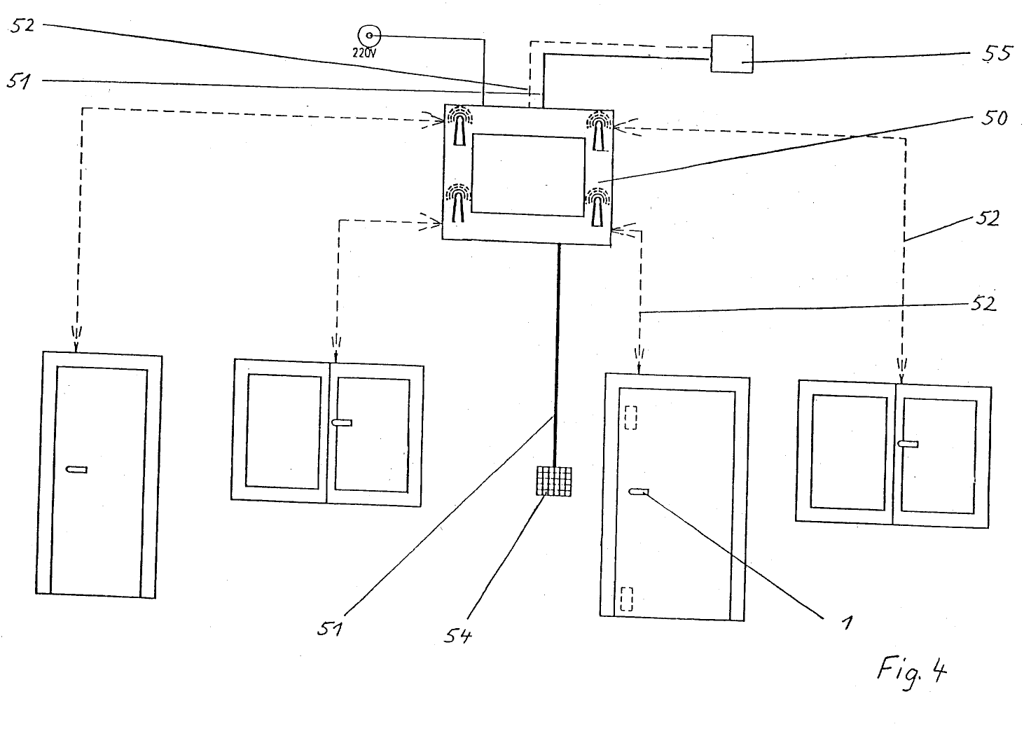

FIG. 4 shows the schematic layout of a centrally controlled closure system employing locks per this invention.

A first form of implementation of a lock 1 per the invention, illustrated in FIG. 1, includes a bolt 2, a catch 3, an auxiliary catch pin 4 and a reciprocator 5. From its locked position shown in FIG. 1, the bolt 2 can be moved into the open position either by means of the closing thruster or by operating the latch nut 6 via the release lever 15 in conjunction with the catch 3. As the bolt 2 is moved into its open position, a spring 7 or other elastic element is cocked for its return to the closed position while a spring-loaded stop lug that engages in a detent in the bolt holds it in the open position until it is released by the door being closed.

An essential component in the self-latching lock 1 per this invention is a preferably electric, remotely controllable nut-locking device 8. The latter includes a spring 31 that cocks a pivot lever 32 and holds the detent pawl 33 of the latter in a recess provided in the perimeter of the latch nut 6, thus inhibiting any movement of the nut 6. Via remote electric actuation the nut-locking device 8 can be deactivated. This is accomplished for instance by means of a lifting or pull-type electromagnet 34 which, when energized, moves a rocker 35 that in turn swivels the pivot lever 32 in such a way as to lift the detent pawl 33 out of the recess in the nut 6, enabling the nut 6 to move freely.

It is this remotely controllable nut-locking device 8 that makes the self-latching lock 1 per the invention suitable for use in modern, centrally controlled and monitored closure systems. The remotely controllable nut-locking system 8 makes it possible in conventional closure systems to do away with the compromise of a “door opener”, working in unison with the catch 3 and mounted in the striker plate or in the door frame, a concept that offers only modest intrusion resistance. The nut-locking system 8 even allows for a latch to be provided on the outside of the door. That in turn makes it possible, when the nut-locking device 8 is deactivated, to retract the self-latching bolt 2 even from the outside of the door by means of the latch and a release lever 15. Accordingly, self-latching locks, with their high level of intrusion resistance, can be employed in modern, centrally controlled and monitored closure systems. In a closure system of that type, it is possible for instance to use the traditional magnetic card key to briefly deactivate the nut-locking device 8, permitting access to the room, meaning that by releasing the nut it is possible to use the latch for retracting the catch and bolt. As soon as the magnetic card is withdrawn, the nut-locking device is automatically reactivated so that, when the door is closed, the catch 3 will enter the striker plate and the bolt 2, released by the auxiliary catch pin 4, will move into the full lock-out position. With the magnetic card removed, the latch can no longer be actuated, leaving the door locked in particularly secure fashion by means of both the catch 3 and the self-locking bolt 2.

FIGS. 2 and 3 illustrate another advantageous form of implementation of the invention. The operating principle of this self-latching lock version of the invention is essentially the same as that of the configuration shown in FIG. 1 and described above. In this second design version, however, the function of the latch nut is deactivated, not by a nut-locking device but by a nut-idling feature. In other words, in this design version the movement of the latch, or both latches, is not inhibited; instead, a remotely controllable slip coupling makes certain that, whenever the door is to remain in the locked state, the movement of the latch or latches on the outside and/or inside of the door cannot be transferred to the latch nut. In the configuration depicted in FIGS. 2 and 3, and better recognized in FIG. 3, this idling function is assured in that the latch nut features an outer nut body 60 with each one arm 61, 62 for actuating the catch 3 and the bolt 2, respectively. Provided inside the outer nut body 60 in coaxial and parallel fashion are two rotatable gudgeons 63, 64 for the spindles of the outside and inside latches. As shown in FIG. 3, a round-ended spring-loaded carrier dog 65, 66 protrudes radially from the perimeter of each gudgeon 63, 64 and into peripheral tracks 67, 68 recessed into the outer nut body 60, each at an angular length of about 50°. When the latch is not being operated, the carrier dogs 65, 66 are positioned in front of and close to the ends of the peripheral tracks, as viewed in the direction of movement of the gudgeons 63, 64. The peripheral tracks 67, 68 terminate in stops 69, 70 for the lateral surfaces of the protruding carrier dogs 65, 66. When the latch is pushed, and after a brief no-load movement, the lateral surface of the corresponding protruding carrier dog 65, 66 strikes against the stop 69, 70, thus carrying the outer nut body 60 along. This movement of the outer nut body 60 and its associated arms 61, 62 causes the catch 3 and the bolt 2 of the self-latching lock 1 per this invention to retract into the open position.

To prevent unauthorized persons from being able to retract the catch 3 and bolt 2 by pushing the latch, the configuration shown in FIGS. 2, 3 and 3a attains the idling function between the latch and the latch nut in that actuators 71, 72, remote-controllable by an electric signal, are rotated into the space that is created in the home positions of the latches between the carrier dogs 65, 66 and the stops 69, 70. The actuators 71, 72 are situated on a plate on the perimeter of the outer nut body. For a better understanding of their function, the two actuators 71, 72, situated on the plate 73 and visible from the top in FIG. 4, are shown in a lateral aspect in FIG. 3a, with the horizontal position of the actuators representing the idling status as illustrated in FIG. 3.

Rotating the respective actuator 71, 72 into the space that is created between the carrier dog 65, 66 and the stop 69, 70 when the latch is in its home position, causes the rounded end of the carrier dog 65, 66 to be pushed back by the slope on the front end of the actuator 71, 72, against the action of the compression spring, to a point where any further rotation of the respective gudgeon 63, 64 moves the front face of the carrier dog 65, 66 under the inside perimeter of the outer nut body 60, so that the lateral surface of the corresponding carrier dog 65, 66 does not push against the respective stop 69, 70 and the movement of the gudgeon 63, 64 concerned is not transferred to the outer nut body 60. Consequently, rotating the actuator 71, 72 into said spaces produces an idling function between the associated latch and the outer nut body 60, preventing any retraction of the catch 3 and the bolt 2. In other words, even when the latch is pushed the door cannot be opened. Authorized persons, using for instance a magnetic card key, can still move the actuators 71, 72 out of the spaces between the carrier dogs 65, 66 and the stops 69, 70, thus deactivating the idling function and allowing the door to be opened.

In desirable fashion, the lock 1 per this invention, illustrated in FIG. 2, is additionally equipped with a gear-segment lever 74 that is permanently coupled to the gudgeons 63, 64, with the teeth of the gear segment meshing with the drive pinion of a generator 75 that is housed in the lock. Any time the latch is pushed, whether in the idle mode or for actuating the locking elements, the gear-segment lever 74 causes the generator 75 to produce electric energy that is stored in a buffer, not shown, making the lock 1 in this particular implementation of the invention independent of any external energy source or batteries for assuring its electrical functions. Even if after extended non-use of the latches the buffer storage unit lacks enough energy for actuating the electrical or electronic components of the lock, pushing the latch instantly supplies the necessary electric power.

To insure that in a panic situation it is possible at any time to open the door from the inside simply by pushing the latch, without a key, magnetic card or the like, the nut-locking device 8 to be used is a split-nut design in which the nut-locking function works only in conjunction with the nut segment associated with access from the outside of the door. In this fashion the nut-locking device 8 deactivates only the latch on the outside of the door while the latch on the inside of the door permits the catch and the bolt to be retracted at any time, allowing the door to be opened.

When a nut-idling device 8 is used, the panic feature is assured in that the actuator 72 is permanently in the neutral, non-rotated state so that the carrier dog 66 of the inside gudgeon 64 always pushes against the stop 70 of the outside nut body and is able to move that. However, it is also possible in certain situations to rotate the actor 72 between the carrier dog 66 and the stop 70 to intentionally disable the panic feature.

In another desirable design variation of the invention the lock can be additionally equipped with a mechanically and/or electrically operated, and for instance even remotely controllable, inhibitor 9 for selectively disabling the self-latching feature of the self-latching lock 1.

In the design example here described the inhibitor 9 features a detent 21 which, under the action of a spring 22, engages in a recess in the bolt 2 when the bolt is in the open position, holding the bolt in that open position. The inhibitor 9 can be disengaged for instance by a remotely controlled lifting or pull-type electromagnet 23 which, as shown in FIG. 1, rotates the detent 21 of the inhibitor 9 out of the recess in the bolt.

The ability to centrally remote-control the inhibitors 9 for instance in emergency situations with simultaneous central deactivation of the nut-locking or idling devices 8 makes it possible to allow all doors to be opened from the outside as well.

In an advantageous form of implementation of this invention, at least one moving part of the lock, especially the bolt 2 and/or the catch 3 and/or the auxiliary catch pin 4 is/are provided with a sensor or several sensors allowing the determination of the position of the moving part(s) at any given time.

For further processing, that positional information can be fed to a remote central station or to a control unit 12 located in the lock 1 and serving to control the electrically operated devices such as the nut-locking or idling device 8 or the inhibitor 9 for the self-latching feature. The data transmission system may be hard-wired or wireless. For wireless transmission a transceiver unit 13 is provided, possibly integrated into the control unit 12. The transceiver unit 13 may be of the radio-operated type.

In a desirable design version of the invention, the lock-out function of the bolt 2 additionally depends on the entry of the catch 3 into the striker plate. This prevents premature dead-bolt extension of the bolt that might otherwise damage the door frame or the striker plate.

To dampen the clicking sound when the bolt snaps into its lock-out position, at least one of the bolt guides, i.e. either the bolt guide pin or the rear end of the bolt guide slot may include an elastic sound attenuator.

In addition, in order to increase the counteracting force of the bolt for further enhanced break-in resistance, the bolt guide pin that connects to the lock case may be linked via a bridge element 17 to another lock segment that is connected to the lock case, or directly to the lock case itself.

FIG. 4 is a schematic illustration of a closure configuration according to this invention, employing self-latching locks 1 per the invention and a central control system 50.

In the implementation example illustrated, at least all of the doors in the building concerned are equipped with self-latching locks 1 per this invention and are in a constantly locked state by way of the nut-locking or idling device 8 and the fully extended bolt 2. A code scanner 54 next to the door (FIG. 4 shows such a code scanner 54 only next to the main entrance door) in combination with the central control system 50 allows an authorized person to deactivate the nut-locking or idling device 8, enabling that authorized person, by pushing the outside latch, to retract the catch 3 and, via the release lever 15, the bolt 2. A one-time scan by the code scanner releases the nut-locking or idling device 8 for only a one-time opening of the door. When the door is closed again, the nut-locking or idling device 8 and the self-latching bolt 2, controlled by the central control unit, are promptly reactivated, which secures the building in previously unattainable fashion against break-in.

In the implementation example illustrated, the code scanner 54 is hard-wired to the central control unit 50 while the return signal from the control unit to the lock in the main entrance door is transmitted via a wireless link. Of course, the connections may be made in any suitable fashion, for instance all wireless.

The central control unit 50 is programmed or manually controlled via the control panel 55 which on its part is connected to the central control unit 50 either through lines 51 or wireless links 52.

Based on this invention, it is now possible in simple fashion to employ even self-latching locks in a modern closure system, which can significantly improve the intrusion protection of buildings secured by centrally controlled closure systems.

Moreover, it is now possible to do without the traditionally used door openers that are installed in the striker plate or in the door frame, offering little security, including their relatively complex installation.

1. Self-latching lock (1) encompassing a bolt (2), catch (3), auxiliary catch pin (4), and reciprocator (5), in which the bolt (2) that can be operated via a latch nut (6) or a closing thruster is cocked, when the door is open, by an elastic element (7) for locking action and, when the door leaf is engaged in the door rabbet, is released into its locking position by the action at least of the auxiliary catch pin (4), characterized by a nut-locking or idling device (8) that permits temporary activation of the latch function as well as deactivation preferably by remote electric actuation.

2. Self-latching lock (1) as in claim 1, characterized by the use of a multi-part latch nut of which the electrically operated, remotely actuated nut-locking or idling device (8) cooperates at least with the nut segment pointing toward the outside of the door.

3. Self-latching lock (1) as in claim 1 or 2, characterized in that the bolt (2) is equipped with an inhibitor (9) serving to temporarily disable the self-latching function.

4. Self-latching lock (1) as in claim 3, characterized in that the inhibitor (9) can be operated and remotely actuated by mechanical and/or electric means.

5. Self-latching lock (1) as in at least one of the preceding claims, characterized by an electrically operated, remotely controllable nut-locking device (8) for selectively preventing the operation of the latch at least on the outside of the door.

6. Self-latching lock (1) as in at least one of the preceding claims 1 to 4, characterized by an electrically operated, remotely controllable nut-idling device (8) for the selective transfer or non-transfer of the latch movement at least on the outside of the door.

7. Self-latching lock (1) as in claim 6, characterized in that the nut-idling device (8) encompasses an outer nut body (6) with each one arm (61, 62) for operating the catch (3) and bolt (2), two gudgeons (63, 64) rotatably positioned inside the outer nut body (60) in coaxial and parallel fashion, and, for each gudgeon (63, 64), a coupling that can be deactivated via actuators (71, 72), between the gudgeons (63, 64) and the outer nut body (60).

8. Self-latching lock (1) as in claim 7, characterized in that the coupling between the gudgeons (63, 64) and the outer nut body (60) includes in each gudgeon a carrier dog (65, 66) with a rounded end, radially protruding outward in spring-loaded fashion from the gudgeon into each one track (67,68), recessed into the perimeter of the outer nut body (60) at an angular length of about 50°, and extending close to each one stop-shaped end (69, 70) of the recessed track (67, 68), and that the coupling is deactivated by engaging an actuator (71, 72), with a sloped front side opposite the rounded end of the carrier dog, in the interstitial space between the stop (69, 70) and the carrier dog (65, 66) that pushes the carrier dog back into the gudgeon (63, 64) when that is moved.

9. Self-latching lock (1) as in at least one of the preceding claims, characterized by a gear-segment lever (74) that is permanently coupled to the gudgeons (63, 64) for driving an electric generator mounted inside the lock (1).

10. Self-latching lock (1) as in at least one of the preceding claims, characterized in that at least one of the moving parts of the lock and especially the bolt (2) and/or the catch (3) and/or the auxiliary catch pin (4) is/are provided with one or several sensor(s) (10, 11) for the detection of its/their position at any given time.

11. Self-latching lock (1) as in at least one of the preceding claims, characterized in that the lock (1) incorporates at least one control unit (12) for controlling the electrically operated devices under interpretative utilization of the signals captured by the sensor(s) (10, 11) and in response to instructions sent to the control unit (12) from outside the lock.

12. Self-latching lock (1) as in claim 11, characterized in that the control unit (12) is connected to a transceiver unit (13) inside the lock for the purpose of receiving and forwarding wirelessly transmitted signals.

13. Self-latching lock (1) as in at least one of the preceding claims, characterized in that the transceiver unit (13) is a radio transceiver.

14. Self-latching lock (1) as in at least one of the preceding claims, characterized in that the lock-out extension of the bolt (2) is additionally dependent on the entry of the catch (3) in the striker plate.

15. Self-latching lock (1) as in at least one of the preceding claims, characterized in that in the catch area at least one of the bolt-guiding elements is provided with an attenuating element for damping the clicking sound when the bolt snaps into its extended lock-out position.

16. Self-latching lock (1) as in at least one of the preceding claims, characterized in that the bolt guide element connected to the lock case is linked via a bridge element (17) to another lock segment that is connected to the lock case, or is linked to the lock case itself.

17. Closure system with a central control device (50) that is connected, via hard-wired lines (51) and/or wireless links (52), to the locks of lockable openings in buildings such as doors or windows, characterized in that, at least for the doors concerned, self-latching locks (1) are used that are equipped with an electrically operated, remotely controllable nut-locking or idling device (8) for the temporary activation of the latch function as defined in claims 1 to 16.
